(19) United States
(12) Patent Application Publication
(10) Pub. No.: US 2013/0139123 A1
(43) Pub. Date: May 30, 2013

(54) COMPUTING DEVICE AND METHOD FOR CIRCUIT DIAGRAM DATA CHECK

(71) Applicants: CONG-FENG WEI, Tu-Cheng (TW); YU-HAO CHANG, Tu-Cheng (TW)

(72) Inventors: CONG-FENG WEI, Tu-Cheng (TW); YU-HAO CHANG, Tu-Cheng (TW)

(21) Appl. No.: 13/656,896

(22) Filed: Oct. 22, 2012

(30) Foreign Application Priority Data
Nov. 28, 2011 (TW) 100143491

(51) Int. Cl. G06F 17/50

(52) U.S. Cl. 716/136

(57) ABSTRACT

A method to check circuit diagram data using a computing device. The computing device inserts the circuit diagram data into an application having an ordering function. The computing device sets a condition to screen out the circuit diagram data in the application having the ordering function, and reads an item of the circuit diagram data. The computing device marks the item of the circuit diagram data if the item of the circuit diagram data does not satisfy the condition.

### BACKGROUND

1. Technical Field

Embodiments of the present disclosure relate to data management, and particularly to a computing device and method for circuit diagram data check.

2. Description of Related Art

When a user designs a circuit diagram using a circuit diagram designing application, circuit diagram data (e.g., label numbers of components in the circuit diagram) are simultaneously generated. Sometimes, the circuit diagram data may be incorrect. For example, a component of the circuit diagram is supposed to be labeled as “F”, but the component of the circuit diagram is actually labeled as “D” by mistake. Therefore, the designer needs to check if the circuit diagram data are correct. However, at present, the designer manually checks the circuit diagram data, which is very time-consuming, especially when the circuit diagram data are huge and complicated. Therefore, there is room for improvement in the art.

### BRIEF DESCRIPTION OF THE DRAWINGS

FIG. 1 is a schematic diagram of one embodiment of a computing device including a circuit diagram data check system.

FIG. 2 is a block diagram of one embodiment of the circuit diagram data check system of FIG. 1.

FIG. 3 is a flowchart of one embodiment of a circuit diagram data check method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

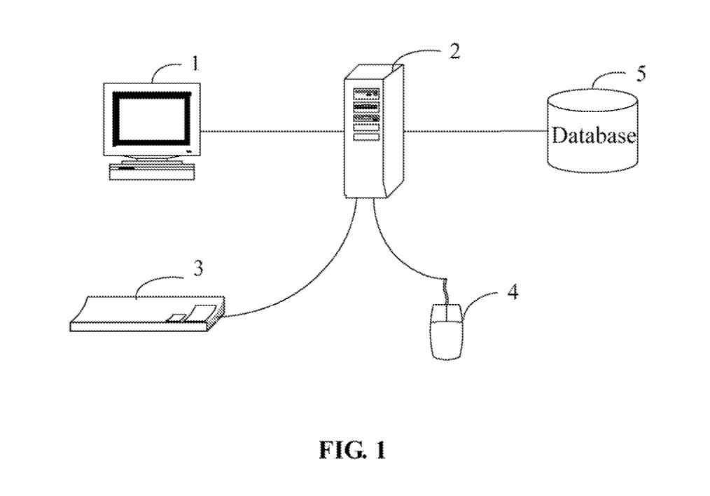

In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computing device-readable medium or other storage device. Some non-limiting examples of non-transitory computing device-readable media include CDs, DVDs, BLU-RAY, flash memory, and hard disk drives. The term, “data” may refer to a single data item or may refer to a plurality of data items. These terms, with reference to the FIGS. 1-3, will be described in greater detail below.

FIG. 1 is a schematic diagram of one embodiment of a computing device 2. The computing device 2 comprises a plurality of peripherals that are connected to the computing device 2, such as a display device 1, a keyboard 3, and a mouse 4. The peripherals may be used to input or output various computing device signals or interfaces. The database 30 may store circuit diagram data. The circuit diagram data are generated by a circuit diagram designing application. The circuit diagram data may include, a label number of each component (e.g., a diode, a capacitor, or an inductor), a net name of each signal wire, a label number of each node of each signal wire, and remarks (e.g., “the circuit diagram is designed for a motherboard of the computing device 2,” or “the node A is a power connection”). Additionally, the computing device 2 provides an operation interface for a user to control one or more operations of the computing device 2.

The computing device 2 is installed with an application having an ordering function. The application may be, but is not limited to, MICROSOFT EXCEL. The application screens out the circuit diagram data using the ordering function. The ordering function provides one or more order algorithms (e.g., a descending order, an ascending order).

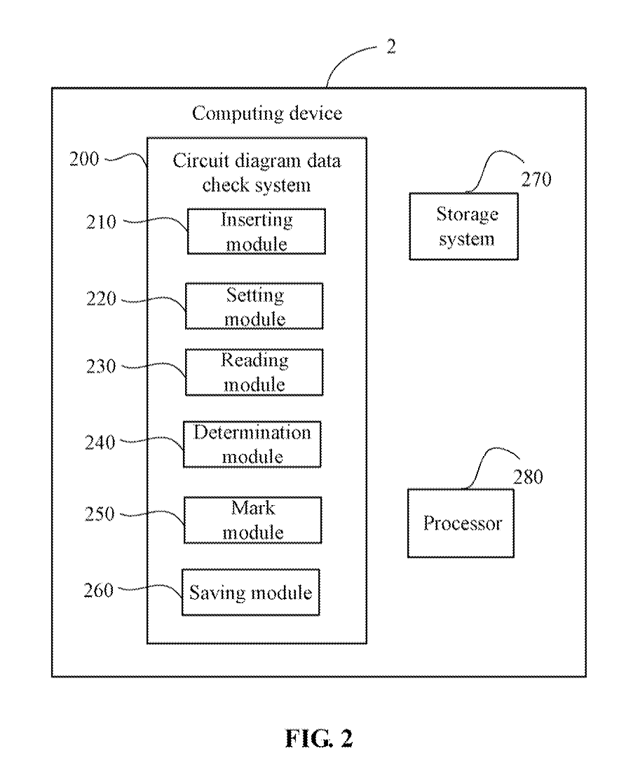

FIG. 2 is a block diagram of one embodiment of a circuit diagram data check system 200. The circuit diagram data check system 200 may be used to automatically check the circuit diagram data. In one embodiment, the circuit diagram data check system 200 includes an inserting module 210, a setting module 220, a reading module 230, a determination module 240, a mark module 250, and a saving module 260. The modules 210-260 may include computerized code in the form of one or more programs that are stored in the storage system 270. The computerized code includes instructions that are executed by the at least one processor 280 to provide functions for the modules 210-260. The storage system 270 may be a memory device, such as an erasable programmable read only memory (EPROM), a hard disk drive (HDD), or a flash memory.

The inserting module 210 inserts the circuit diagram data into the application having the ordering function. In one embodiment, a user may design the circuit diagram using the circuit diagram designing application and generates one or more items of the circuit diagram data, and the inserting module 210 inserts the circuit diagram data into MICROSOFT EXCEL from the circuit diagram designing application.

The setting module 220 sets a condition to screen out the circuit diagram data in the application having the ordering function. The condition may be one or more keywords set by a user. The one or more keywords are associated with the label numbers of the components, for example, the keywords may be the label number of the capacitor, and the label number of the inductor.

The reading module 230 reads an item of the circuit diagram data. In one embodiment, the circuit diagram data may include one or more items of the circuit diagram data, the reading module 230 reads the one or more items of the circuit diagram data one by one in a predefined order (e.g., the descending order of the label numbers). In additions, if the item of the circuit diagram data has been read, the reading module 230 associates a status tag with the item of the circuit diagram data. The status tag indicates that the item of the circuit diagram data has been read. The status tag may be a piece of information (e.g., “the item of the circuit diagram data has been read.”)

The determination module 240 determines if the item of the circuit diagram data satisfies the condition. In one embodiment, the determination module 240 determines if the item of the circuit diagram data includes the keywords. If the item of the circuit diagram data includes the keywords, the item of the circuit diagram data satisfies the condition.

The mark module 250 marks the item of the circuit diagram data if the item of the circuit diagram data does not satisfy the condition. In one embodiment, if the item of the circuit diagram data does not satisfy the condition, the mark module 250 highlights the item of the circuit diagram data in a predefined color, such as red, or underlines the item of the circuit diagram data. The mark module 250 may also output a report to show position information of the item of the circuit diagram data, thereby users may find the differences easily and quickly.

The determination module 240 determines if all of the circuit diagram data have been read. In one embodiment, if all of the circuit diagram data are associated with the status tag, the determination module 240 determines that all of the circuit diagram data have been read.

The saving module 260 saves the circuit diagram data into the database 5. In one embodiment, regardless if the circuit diagram data satisfies the condition or not, the saving module 260 still saves the circuit diagram data into the database 5.

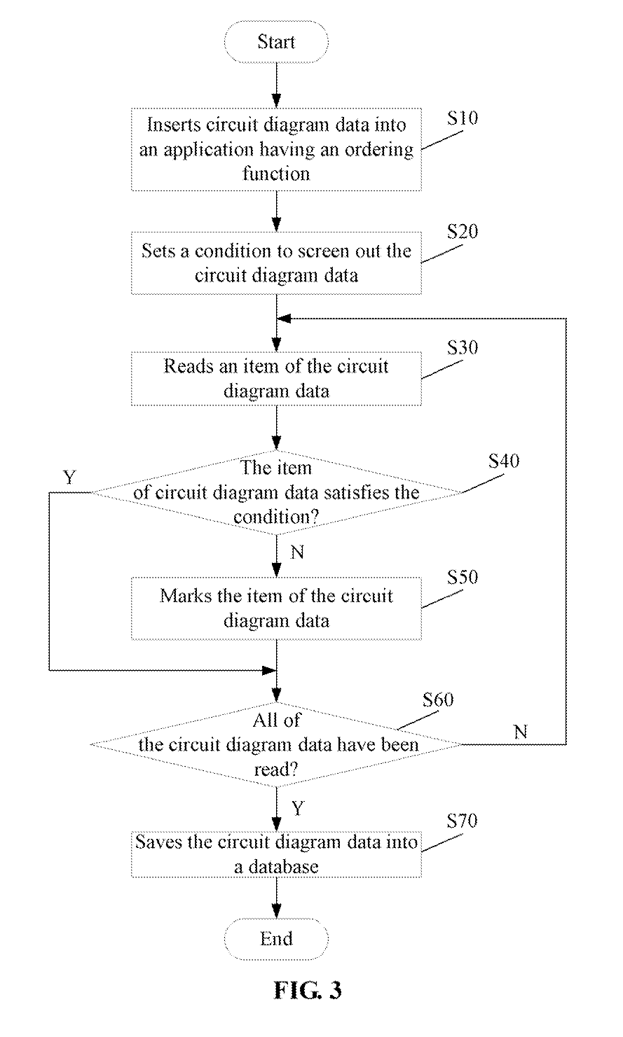

FIG. 3 is a flowchart of one embodiment of a circuit diagram data check method. Depending on the embodiment, additional steps may be added, others deleted, and the ordering of the steps may be changed.

In step S10, the inserting module 210 inserts the circuit diagram data into the application having the ordering function. For example, the inserting module 210 inserts the circuit diagram data into MICROSOFT EXCEL from CADENCE CAPTURE.

In step S20, the setting module 220 sets a condition to screen out circuit diagram data. For example, the condition may be one or more keywords “A” and “B,” wherein “A” may be the label number of the capacitor, and “B” may be the label number of the inductor.

In step S30, the reading module 230 reads an item of the circuit diagram data. As mentioned above, if the item of the circuit diagram data has been read, the reading module 230 associates a status tag with the item of the circuit diagram data.

In step S40, the determination module 240 determines if the item of the circuit diagram data satisfies the condition. In one embodiment, if the item of the circuit diagram data does not satisfy the condition, the procedure goes to step S50. For example, if the item of the circuit diagram data does not contain the keywords “A” or “B”, the procedure goes to step S50. Otherwise, if the item of the circuit diagram data satisfies the condition, the procedure goes to step S60. For example, if the item of the circuit diagram data contains the keywords “A” or “B”, the procedure goes to step S60.

In step S50, the mark module 250 marks the item of the circuit diagram data if the item of the circuit diagram data does not satisfy the condition. In one embodiment, if the item of the circuit diagram data does not satisfy the condition, the mark module 250 highlights the item of the circuit diagram data in a predefined color, such as red, or underlines the item of the circuit diagram data. The mark module 250 may also output a report to show position information of the item of the circuit diagram data, thereby users may find the differences easily and quickly. Additionally, the report can be printed by a printer or displayed on the display device 1.

In step S60, the determination module 240 determines if all of the circuit diagram data have been read. For example, if all of the circuit diagram data are associated with the status tag, the procedure goes to step S70. Otherwise, if one item of the circuit diagram data is not associated with the status tag, the procedure returns to step S30.

In step S70, the saving module 260 saves the circuit diagram data into the database 5. As mentioned above, regardless of the circuit diagram data that satisfy the condition or not, the saving module 260 still saves the circuit diagram data into the database 5.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs stored in the storage system and being executable by the at least one processor, the one or more programs comprising:
an inserting module inserts circuit diagram data into an application having an ordering function;
a setting module sets a condition to screen out the circuit diagram data in the application having the ordering function;
a reading module reads an item of the circuit diagram data; and
a mark module marks the item of the circuit diagram data if the item of the circuit diagram data does not satisfy the condition.

2. The computing device of claim 1, wherein the circuit diagram data comprise a label number of each component, a net name of each signal wire, a label number of each node of each signal wire, and remarks.

3. The computing device of claim 1, wherein the computing device further comprises a saving module, wherein the saving module saves the circuit diagram data into a database connected to the computing device.

4. The computing device of claim 1, wherein the reading module associates a status tag with the item of the circuit diagram data if the item of the circuit diagram data has been read.

5. The computing device of claim 1, wherein the condition is one or more keywords, wherein the one or more keywords are associated with the label number of the component.

6. The computing device of claim 5, wherein the item of the circuit diagram data satisfies the condition when the item of the circuit diagram data comprises the keywords.

7. A circuit diagram data check method implemented by a computing device, the method comprising:
inserting circuit diagram data into an application having an ordering function;
setting a condition to screen out the circuit diagram data in the application having the ordering function;
reading an item of the circuit diagram data; and
marking the item of the circuit diagram data if the item of the circuit diagram data does not satisfy the condition.

8. The method of claim 7, wherein the circuit diagram data comprise a label number of each component, a net name of each signal wire, a label number of each node of each signal wire, and remarks.

9. The method of claim 7, wherein the circuit diagram data are further saved into a database connected to the computing device.

10. The method of claim 7, wherein a status tag is associated with the item of the circuit diagram data if the item of the circuit diagram data has been read.

11. The method of claim 7, wherein the condition is one or more keywords, wherein the one or more keywords are associated with the label number of the component.

12. The method of claim 11, wherein the item of the circuit diagram data satisfies the condition when the item of the circuit diagram data comprises the keywords.

13. A non-transitory computing device-readable medium having stored thereon instructions that, when executed by a computing device, causing the computing device to perform a circuit diagram data check method, the method comprising:
inserting circuit diagram data into an application having an ordering function;
setting a condition to screen out the circuit diagram data in the application having the ordering function;
reading an item of the circuit diagram data; and
marking the item of the circuit diagram data if the item of the circuit diagram data does not satisfy the condition.

14. The non-transitory medium of claim 13, wherein the circuit diagram data comprise a label number of each component, a net name of each signal wire, a label number of each node of each signal wire, and remarks.

15. The non-transitory medium of claim 13, wherein the circuit diagram data are further saved into a database connected to the computing device.

16. The non-transitory medium of claim 13, wherein a status tag is associated with the item of the circuit diagram data if the item of the circuit diagram data has been read.

17. The non-transitory medium of claim 13, wherein the condition is one or more keywords, wherein the one or more keywords are associated with the label number of the component.

18. The non-transitory medium of claim 17, wherein the item of the circuit diagram data satisfies the condition when the item of the circuit diagram data comprises the keywords.
